(19) United States
(12) Patent Application Publication
(10) Pub. No.: US 2010/0109846 A1
(43) Pub. Date: May 6, 2010

(54) MICROSTRIP ANTENNA AND APPARATUS FOR READING RFID TAG INFORMATION

(75) Inventor: Takuya NAGAI, Aichi-ken (JP)

Correspondence Address: DAY PITNEY LLP, 7 TIMES SQUARE, NEW YORK, NY, 10036-7311, US

(73) Assignee: Brother Kogyo Kabushiki Kaisha, Aichi-ken (JP)

(21) Appl. No.: 12/686,725

(22) Filed: Jan. 13, 2010

Related U.S. Application Data
(63) Continuation-in-part of application No. PCT/JP2008/064414, filed on Aug. 11, 2008.

(30) Foreign Application Priority Data
Sep. 5, 2007 (JP) 2007-229861

(51) Int. Cl. H04Q 5/22; H01Q 9/04; H01Q 3/24

(52) U.S. Cl. 340/10.1; 343/700 MS; 343/876

(57) ABSTRACT

This disclosure discloses a microstrip antenna comprising: a substrate constructed by a dielectric body; a microstrip antenna pattern configured to be supplied power, formed on one side of said substrate; and a base plate disposed on the other side of said substrate, said microstrip antenna pattern having one power supply point to be connected to a power supply line and two grounding points to be connected to said base plate.

### CROSS-REFERENCE TO RELATED APPLICATION

This is a Continuation-in-part under 35 U.S.C. §120 of International Application No.: PCT/JP2008/064414, filed Aug. 11, 2008, which was not published under PCT article 21(2) in English. The disclosure of PCT/JP2008/064414 is herein incorporated by reference.

### BACKGROUND OF THE INVENTION

1. Field of the Invention

The present invention relates to a microstrip antenna configured to conduct radio communication with a communication target and an apparatus for reading a radio frequency identification (RFID) tag information configured to read information from RFID tag using this microstrip antenna.

2. Description of the Related Art

An antenna used in radio communication with a communication target having a configuration provided with a function to switch a polarization phase has been known. Typically, a transmitter or a receiver and a branch point is connected to each other through a transmission line, and a plurality of radio frequency transmission lines are branched from the branch point. Also, each of the radio frequency transmission lines reaches a plurality of power supply points of a radiation patch from respective different directions. When a switching element disposed in an intermediate part of each radio frequency transmission line is operated and only one intermediate part is shortened, the polarization phase is switched between horizontal polarization and vertical polarization.

Recently, as a method for reducing a size of a planar antenna such as a patch antenna, a planar inverted F antenna is known. This planar inverted F antenna is provided with a structure in which one apex of a half-wavelength resonant rectangular microstrip antenna is grounded, and a power supply point is disposed on a side including the apex or close to the side including the apex. As a result, a patch area to a microstrip antenna with the same frequency is reduced to approximately ¼.

Also, if information transmission and reception is conducted with an RFID tag, it is known that communication sensitivity can be increased by switching a polarization phase. However, if the planar inverted F antenna is used, switching of the polarization phase is difficult. On the other hand, if the prior art reference is applied to a usual planar patch antenna, switching of the polarization phase can be performed. However, in this case, it is difficult to reduce the size as in the planar inverted F antenna.

### SUMMARY OF THE INVENTION

An object of the present invention is to provide a microstrip antenna capable of switching of a polarization phase in communication and size reduction and an apparatus for reading RFID tag information provided with this microstrip antenna.

### Means for Solving the Problem

In order to achieve the above object, according to the invention, there is provided a microstrip antenna comprising a substrate constructed of a dielectric body; a microstrip antenna pattern configured to supply power, formed on one side of the substrate; and a base plate disposed on the other side of the substrate, the microstrip antenna pattern having one power supply point to be connected to a power supply line and two grounding points to be connected to the base plate.

### BRIEF DESCRIPTION OF DRAWINGS

FIG. 1 is a diagram illustrating an example of a case in which a reader of an embodiment of the present invention is applied to management of a large number of articles to which an RFID tag is attached;

FIG. 2 is a system configuration diagram illustrating an outline of the reader;

FIG. 3 is a functional block diagram illustrating a detailed configuration of a CPU, an radio frequency (RF) communication control part, and a reader antenna unit of the reader;

FIG. 4A is a side view illustrating a detailed structure of a microstrip antenna;

FIG. 4B is a sectional view illustrating a detailed structure of the microstrip antenna;

FIG. 4C is a sectional view illustrating a detailed structure of the microstrip antenna;

FIG. 5A is a perspective view illustrating a structure of the microstrip antenna;

FIG. 5B is a perspective view illustrating a structure of the micro strip antenna;

FIG. 6 is an explanatory diagram illustrating an electric connection relationship between the microstrip antenna and the RF communication control part;

FIG. 7 is a circuit diagram illustrating a detailed configuration example of a matching circuit;

FIG. 8A is a circuit diagram illustrating a detailed configuration example of a switching circuit;

FIG. 8B is a circuit diagram illustrating a detailed configuration example of the switching circuit;

FIG. 8C is a circuit diagram illustrating a detailed configuration example of the switching circuit;

FIG. 9 is a diagram for explaining distribution of charges and voltages in the microstrip antenna provided with a large-sized microstrip antenna pattern;

FIG. 10 is a diagram for explaining distribution of charges and voltages in the microstrip antenna provided with a large-sized microstrip antenna pattern reduced to a half;

FIG. 11 is a diagram for explaining distribution of charges and voltages in the microstrip antenna provided with a large-sized microstrip antenna pattern reduced in size;

FIG. 12 is a plan view of the microstrip antenna when two grounding points are disposed so that two polarization phase directions cross each other at a right angle;

FIG. 13 is a plan view of the microstrip antenna when a dielectric substrate and the microstrip antenna pattern are disposed with offset rotation;

FIG. 14 is a diagram for explaining distribution of charges and voltages in the microstrip antenna provided with a small-sized circular microstrip antenna pattern;

FIG. 15 is a plan view of the microstrip antenna in a variation provided with the circular microstrip antenna pattern; and

FIG. 16 is a plan view of the microstrip antenna in which the dielectric substrate and the circular shaped microstrip antenna pattern are disposed with offset rotation.

### DETAILED DESCRIPTION OF THE PREFERRED EMBODIMENTS

An embodiment of the present invention will be described below referring to the attached drawings.

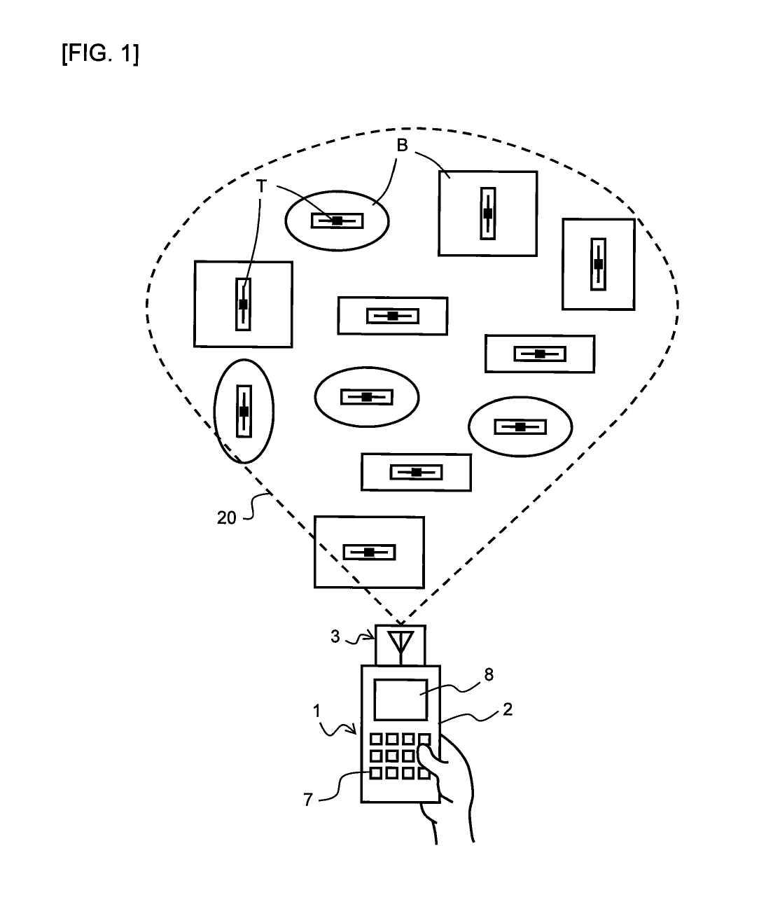

In FIG. 1, in this example, an RFID tag T is attached to each of a large number of articles B arranged at random without alignment. The respective RFID tag T has a tag antenna 151 formed substantially in a linear shape in this example as will be described later in detail. Each of the RFID tags T is attached to each of the articles B in an attitude that a direction in a longitudinal direction of the tag antenna 151 is directed to either of a longitudinal direction or a lateral direction. The direction in the longitudinal direction of this tag antenna 151 is a direction where a potential of a radio wave is changed, which is a so-called direction of a polarization phase.

A reader 1, which is an apparatus for reading RFID tag information of the embodiment, is a handheld type. The reader 1 has a main body control part 2 contained in a substantially solid rectangular housing. On this housing of the main body control part 2, a reader antenna unit 3 capable of switching a polarization phase between a longitudinal direction and a lateral direction is disposed at one end portion in the longitudinal direction, and an operation part 7 and a display part 8 are disposed on one of plane parts of the housing. A specific configuration will be described later in detail.

The reader 1 reads information relating to a corresponding article B from the RFID tag T attached to each of the article B via radio communication. A user also functioning as an administrator of the article B manages a storage situation of each article B by using the reader 1. A communicable area 20, that is, a range indicated by a broken line in the figure of the reader 1 is an area spread from the reader antenna unit 3 as a base point. In the RFID tags present in this communicable area 20, only the RFID tag T whose direction of the polarization phase of the tag antenna 151 matches the direction of the polarization phase of the reader antenna unit 3 can conduct favorable radio communication with the reader 1.

In the illustrated example, the directions of the polarization phases of the tag antennas 151 of a large number of RFID tags T are not uniform but either of the longitudinal direction or the lateral direction. In this case, in order to read information from all the RFID tags T present in the communicable area 20, the reader 1 switches the polarization phase of the reader antenna unit 3 between the longitudinal direction and the lateral direction so as to read the information in each direction via radio communication.

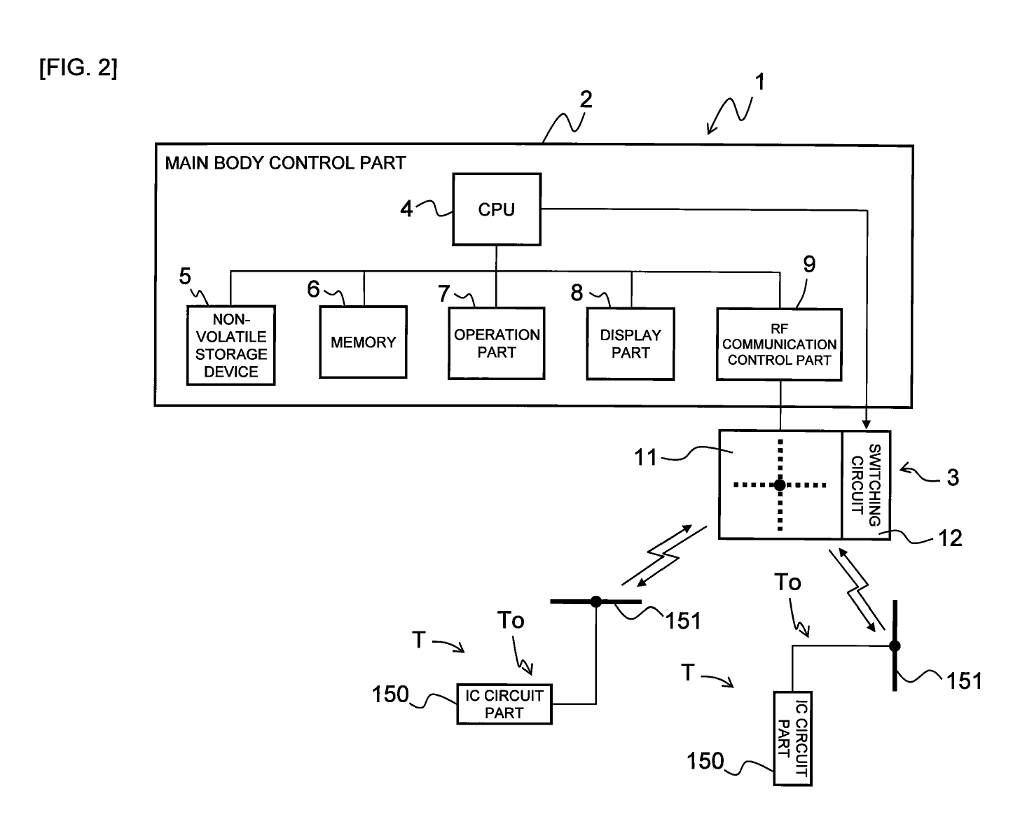

In FIG. 2, the reader 1 has the main body control part 2 and the reader antenna unit 3 as described above. The main body control part 2 has a CPU 4, a non-volatile storage device 5 such as a hard disk device or a flash memory and storing various kinds of information such as a management state of the article B, and a memory 6 such as a RAM and a ROM. Also, the main body control part 2 is provided with the operation part 7 to which instructions and information is inputted from the user, a display part 8 that displays various kinds of information and messages, and an RF communication control part 9 that controls radio communication with the RFID tag T through the reader antenna unit 3.

The reader antenna unit 3 has a microstrip antenna 11 as an apparatus antenna generally formed substantially in a planar shape and a switching circuit 12 that switches a polarization phase direction of the microstrip antenna 11. The microstrip antenna 11 is a so-called patch antenna and its specific configuration will be described later in detail. The switching circuit 12 functions as a switching device and controller.

The CPU 4 executes signal processing according to a program stored in the ROM in advance using a temporary storage function of the RAM so as to perform various control of the entire reader 1.

The RFID tag T has an RFID tag circuit element To provided with the tag antenna 151 and an IC circuit part 150. The RFID tag circuit element To is disposed on a base material, not particularly shown, and the RFID tag T can be attached to the article B. This RFID tag circuit element To will be described later in detail. The tag antenna 151 generally includes a substantially linear dipole antenna, and a longitudinal direction of the dipole antenna is a direction forming the polarization phase.

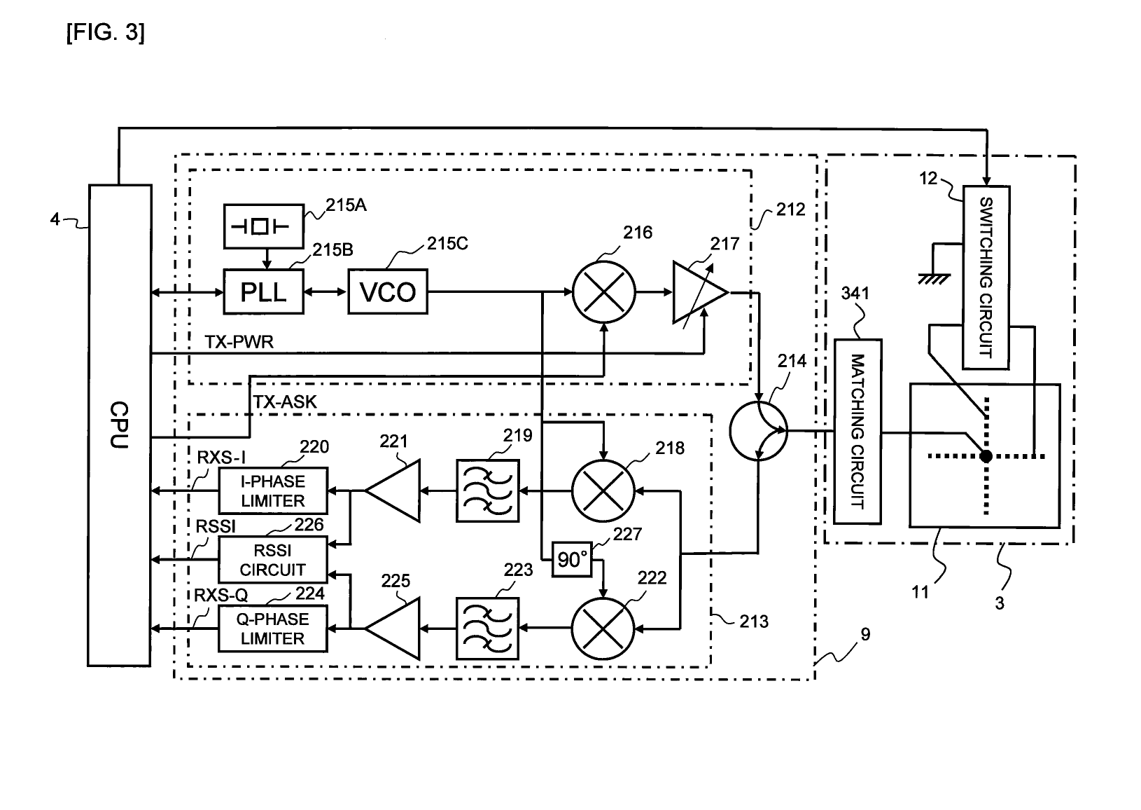

In FIG. 3, the CPU 4 processes a signal read of the IC circuit part 150 of the RFID tag circuit element To so as to read information. Also, the CPU generates various commands to access the IC circuit part 150 of the RFID tag circuit element To.

The RF communication control part 9 makes an access to information of the IC circuit part 150 of the RFID tag circuit element To, that is, RFID tag information including a tag ID through the reader antenna unit 3. The RF communication control part includes a transmitting portion 212, a receiving portion 213, and a transmit-receive splitter 214.

The transmitting portion 212 is a block configured to generate an interrogation wave to access RFID tag information of the IC circuit part 150 of the RFID tag circuit element To through the reader antenna unit 3. The transmitting portion 212 is provided with a crystal oscillator 215A, a Phase Locked Loop (PLL) 215B, a Voltage Controlled Oscillator (VCO) 215C, a transmission multiplying circuit 216, and a variable transmission amplifier 217.

The crystal oscillator 215A generates a reference frequency. The PLL 215B executes control so that a frequency of a carrier wave outputted by the VCO 215C becomes a predetermined frequency based on a command of the CPU 4 according to a frequency generated by the crystal oscillator 215A. The VCO 215C outputs a carrier wave with a frequency determined based on a control voltage generated by the PLL 215B. As the frequency of the generated carrier wave, a UHF band, a micro wave band or a short-wave band frequency, for example, is used.

The transmission multiplying circuit 216 modulates the carrier wave generated based on the signal supplied from the CPU 4. In this example, the transmission multiplying circuit 216 executes amplitude modulation on the basis of a “TX_ASK” signal. In the case of such amplitude modulation, an amplification rate variable amplifier, for example, may be used instead of the transmission multiplying circuit 216.

The variable transmission amplifier 217 amplifies the modulated wave modulated by the transmission multiplying circuit 216. In this example, the variable transmission amplifier 217 performs amplification with an amplification rate determined by a “TX_PWR” signal from the CPU 4. The output of the transmission amplifier 217 is transmitted to a matching circuit 341 of the reader antenna unit 3 and the microstrip antenna 11 through the transmit-receive splitter 214, radiated from the microstrip antenna 11 as an interrogation wave and supplied to the IC circuit part 150 of the RFID tag circuit element To. The interrogation wave is not limited to the modulated signal, that is, the modulated wave, but the wave might be a simple carrier wave.

Into the receiving portion 213, a response wave received at the microstrip antenna 11 of the reader antenna unit 3 and inputted from the RFID tag circuit element To through the matching circuit 341 and the transmit-receive splitter 214 is inputted. The receiving portion 213 is provided with the transmit-receive splitter 214, an I-phase receiving signal multiplying circuit 218, an I-phase lowpass filter 219, an I-phase receiving signal amplifier 221, an I-phase limiter 220, a phase shifter 227, a Q-phase receiving signal multiplying circuit 222, a Q-phase lowpass filter 223, a Q-phase receiving signal amplifier 225, a Q-phase limiter 224, and a Received Signal Strength Indicator (RSSI) circuit 226 as strength detecting means.

The I-phase receiving signal multiplying circuit 218 multiplies and demodulates the response wave from the RFID tag circuit element To received at the microstrip antenna 11 and inputted through the matching circuit 341 and the transmit-receive splitter 214 and the generated carrier wave.

The I-phase lowpass filter 219 takes out only a signal in a required band from the output of the I-phase receiving signal multiplying circuit 218. The I-phase receiving signal amplifier 221 amplifies an output of the I-phase lowpass filter 219. The I-phase limiter 220 amplifies the output of the I-phase receiving signal amplifier 221 and converts it to a digital signal.

The phase shifter 227 delays a phase of the carrier wave generated as above by 90°. The Q-phase receiving signal multiplying circuit 222 multiplies the response wave from the RFID tag circuit element To received at the reader antenna unit 3 and the carrier wave whose phase is delayed by the phase shifter 227 by 90°. The Q-phase lowpass filter 223 takes out only a signal in a required band from the output of the Q-phase receiving signal multiplying circuit 222. The Q-phase receiving signal amplifier 225 amplifies an output of the Q-phase lowpass filter 223. The Q-phase limiter 224 further amplifies the output of the Q-phase receiving signal amplifier 225 and converts it to a digital signal.

A signal “RXS-I” outputted from the I-phase limiter 220 and a signal “RXS-Q” outputted from the Q-phase limiter 224 are inputted into the CPU 4 and processed. The outputs from the I-phase receiving signal amplifier 221 and the Q-phase receiving signal amplifier 225 are inputted into the RSSI circuit 226 and a signal “RSSI” indicating the intensity of these signals is inputted into the CPU 4. As a result, the reader 1 demodulates the response wave from the RFID tag circuit element To by I-Q quadrature demodulation.

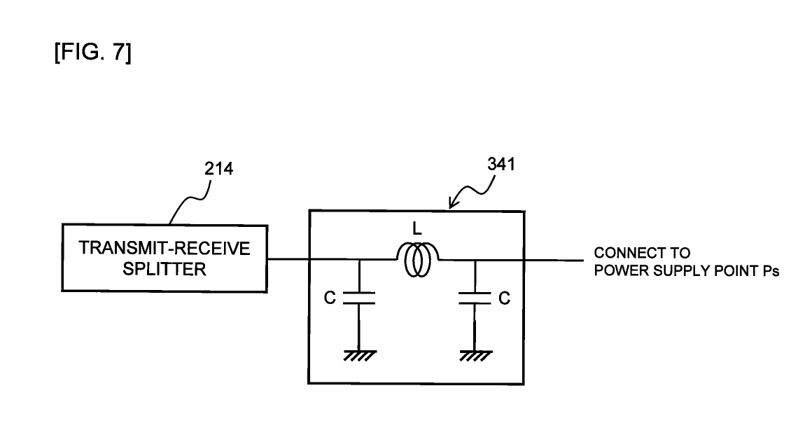

The matching circuit 341 performs impedance matching when the microstrip antenna 11 is connected to the transmitting portion 212 or the receiving portion 213 through the transmit-receive splitter 214 (See FIG. 7, which will be described later). By means of this impedance matching, energy transmission loss in a power supply line, which is a connection line between the microstrip antenna 11 and a path so far can be suppressed.

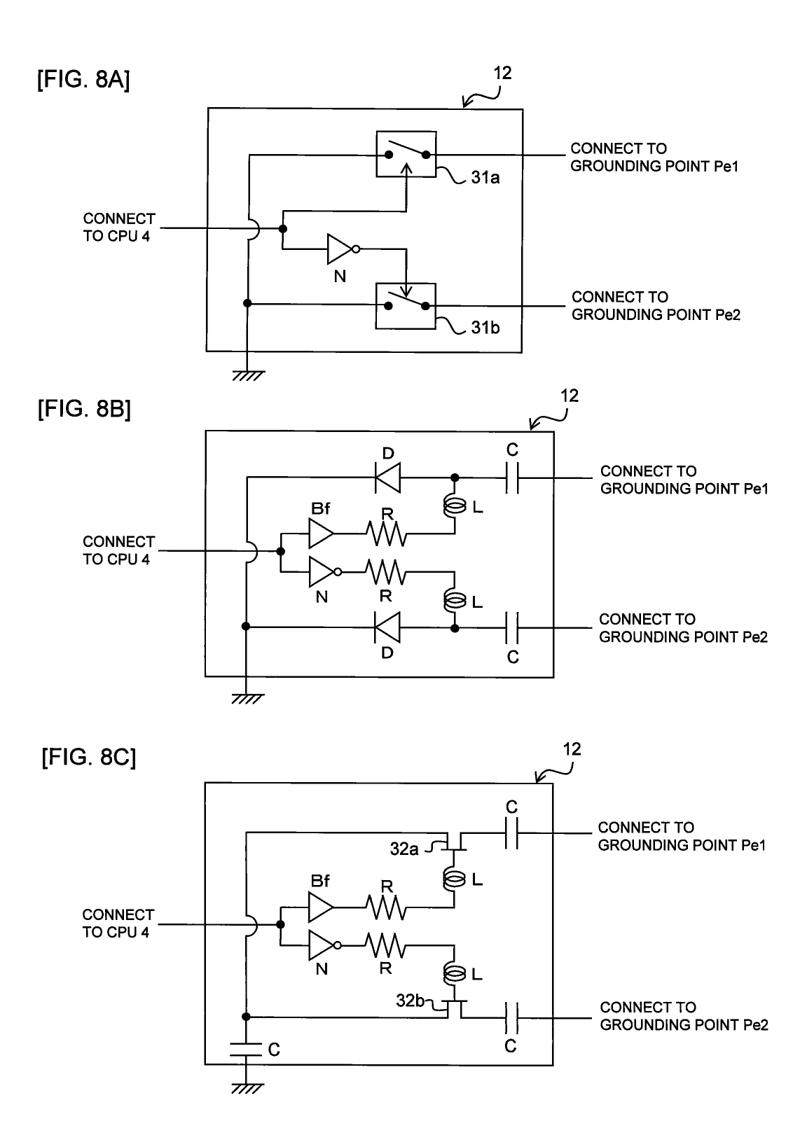

The switching circuit 12 is a switch circuit using a publicly known FET for radio frequency and a diode, for example. The switching circuit 12 connects either of the two grounding points disposed on the microstrip antenna 11 to the base plate 22 by a control signal from the CPU 4. By means of a connection switching operation by this switching circuit 12, the polarization phase direction of the microstrip antenna 11 is switched to either of two directions crossing each other at a right angle, that is, a vertical direction or a horizontal direction shown by a broken line in FIGS. 2 and 3, for example (See FIG. 8, which will be described later).

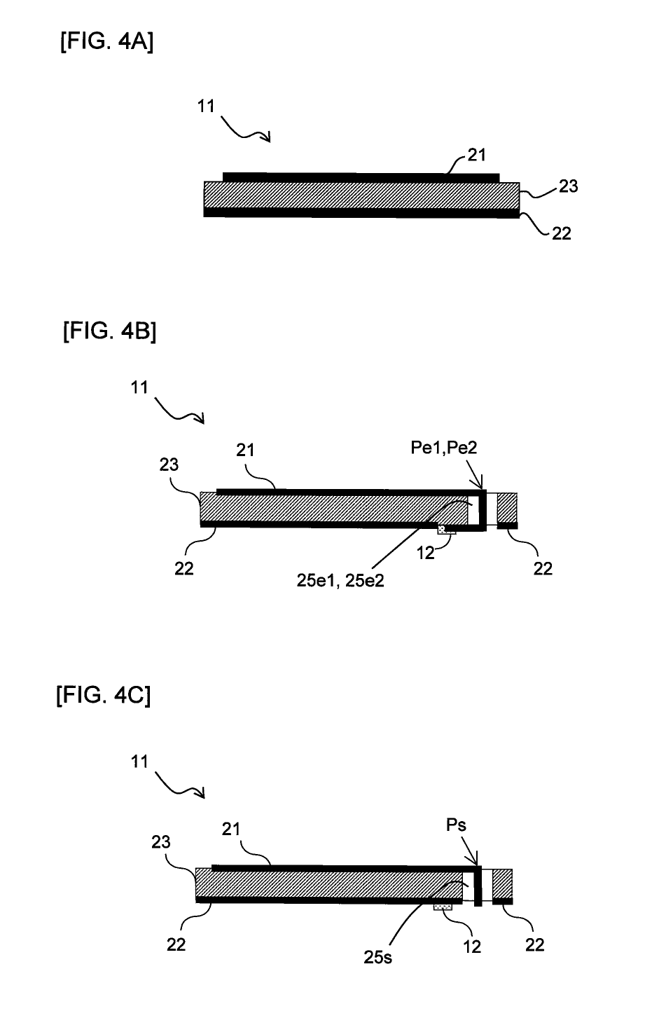

In FIGS. 4A, 4B, and 4C, the microstrip antenna 11 is generally formed substantially in a flat plate shape. The microstrip antenna 11 is provided with a microstrip antenna pattern 21 on a plane on one side, that is, on an upper side in the figure and the base plate 22 on a plane on the other side, that is, on a lower side in the figure. The microstrip antenna 11 is provided with a dielectric substrate 23 in between so as to be sandwiched by the microstrip antenna pattern 21 and the base plate 22.

The microstrip antenna pattern 21 is generally constructed by a conductive material and is formed in a substantially square thin plate shape. The dielectric substrate 23 is generally constructed by a high dielectric material with high dielectric constant. The dielectric substrate 23 is formed in a substantially square thin plate shape with a dimension larger than that of the microstrip antenna pattern 21. The base plate 22 is generally constructed by a conductive material. The base plate 22 is formed in a thin plate shape covering substantially the whole of the plane on the other side of the dielectric substrate 23. In a part of the dielectric substrate 23 on which wiring is formed, a surface thereof is exposed.

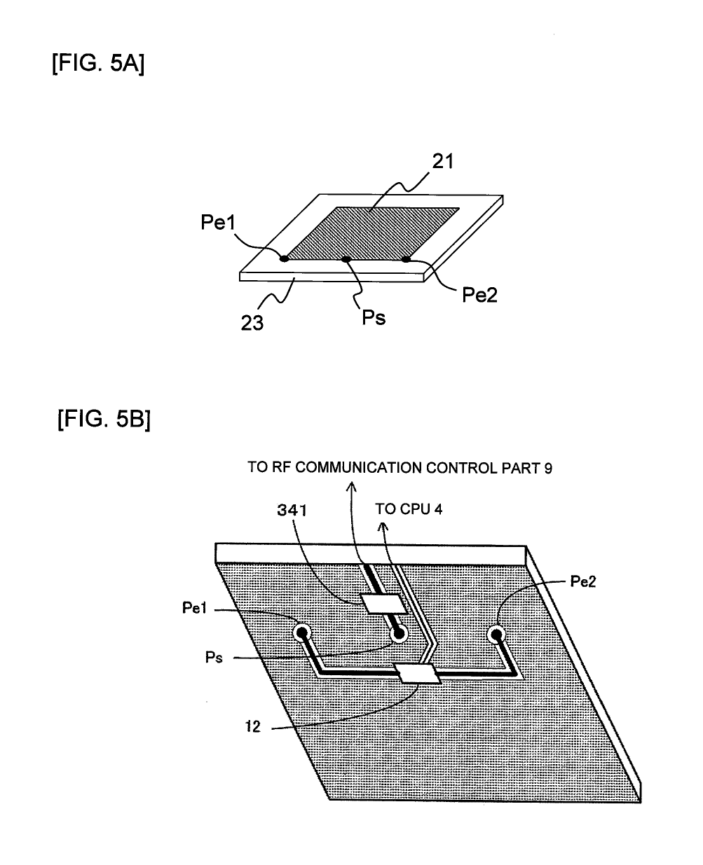

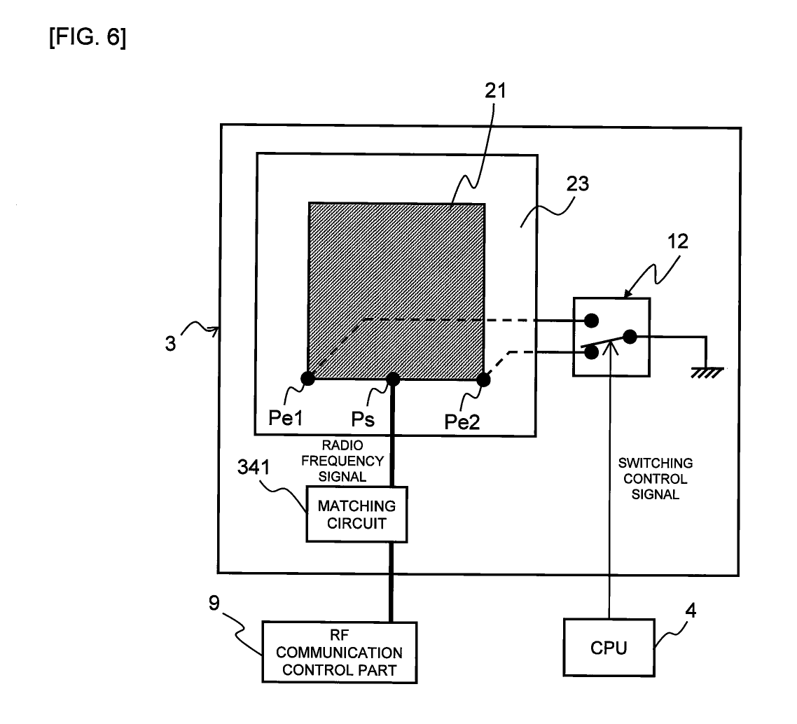

At three spots of the base plate 22 and the dielectric substrate 23, through holes 25s, 25e1, and 25e2 are formed, respectively. The microstrip antenna pattern 21 is connected to the matching circuit 341 (See FIGS. 5B and 6, which will be described later) formed on the base plate 22 through the through hole 25s in the through holes 25s, 25e1, and 25e2. This connection point is a power supply point Ps (See FIG. 4C).

Also, the microstrip antenna pattern 21 is connected to switching circuit 12 disposed on a surface of the base plate 22 through the other through holes 25e1 and 25e2. These connection points are grounding points Pe1 and Pe2. FIG. 4B is a sectional view in common to these two through holes 25e1 and 25e2.

As shown in FIGS. 5A, 5B and 6, on the microstrip antenna pattern 21, the power supply point Ps is disposed on an outer edge portion of the microstrip antenna pattern 21 formed substantially in a square. The power supply point Ps generates a radio wave on the polarization phase corresponding to communication of the RFID tag circuit element To in the microstrip antenna 11. In this example, the power supply point Ps is disposed substantially at the center of a predetermined side of the substantial square. This power supply point Ps is connected to the RF communication control part 9 through the matching circuit 341 of the reader antenna unit 3.

Also, the two grounding points Pe1 and Pe2 are disposed on the outer edge portion of the microstrip antenna pattern 21 formed substantially in a square. The grounding points Pe1 and Pe2 are, in this example, disposed at both ends of one side of the microstrip antenna pattern 21 on which the power supply point Ps is disposed and at corner parts sandwiching the power supply point Ps. At this time, a distance from the grounding point Pe1 to the power supply point Ps and the distance from the grounding point Pe2 to the power supply point Ps is substantially equal to each other. Each of the grounding points Pe1 and Pe2 is connected to the switching circuit 12 through a connection line. The switching circuit 12 connects either of the two grounding points Pe1 and Pe2 to the base plate 22 according to a switching control signal from the CPU 4. By means of this connection switching, the direction of the polarization phase in the microstrip antenna 11 is switched. A specific principle of the switching of polarization phase direction will be described later in detail.

In FIG. 7, in this example, the matching circuit 341 has a publicly known II type configuration. That is, a coil L is connected in serial to the power supply line connecting from the transmit-receive splitter 214 to the power supply point Ps of the microstrip antenna 11. Moreover, connection points at both ends of the coil L are connected so as to be grounded through a capacitor C, respectively. As the matching circuit 341, publicly known T type, L type, dielectric connection type, and a combination thereof may be used other than the above, though not shown.

In the example shown in FIG. 8A, the switching circuit 12 is provided with two 1-input and 1-output type or so-called SPST switches. That is, a signal line into which the control signal is inputted from the CPU 4 is branched into two parts. One of the signals is inputted into a control terminal of an SPST switch 31a on the upper side in the figure as it is. The other signal is inputted into a control terminal of an SPST switch 31b on the lower side in the figure through a negative logic circuit N, which is a so-called NOT circuit. As a result, opening and closing control of the respective SPST switches 31a and 31b is executed. By means of the opening and closing control of the two SPST switches 31a and 31b, connection control is executed so that either one of the two connection points Pe1 and Pe2 disposed on the microstrip antenna 11 is grounded and the other is not grounded.

In this configuration, a signal of either 1 or 0 is inputted into an input signal line from the CPU 4. If 1 is inputted from the CPU 4, for example, a control signal of 1 is inputted as it is to the SPST switch 31a on the upper side in the figure. As a result, the switch 31a is closed to form a closed circuit, and the grounding point Pe1 of the microstrip antenna 11 is grounded. On the other hand, to the SPST switch 31b on the lower side in the figure, a control signal of 0 inverted through the negative logic circuit N is inputted. As a result, the switch 31b is opened to form an open circuit or an open state, and the grounding point Pe2 of the microstrip antenna 11 is brought into a non-grounded state. Also, in case that 0 is inputted from the CPU 4, each of the switches 31a and 31b performs connection operations opposite to each other. In this way, the connection control is executed so that only either one of the two grounding points Pe1 and Pe2 of the microstrip antenna 11 is grounded.

The switching circuit 12 shown in FIG. 8B has a configuration using a diode D. In this configuration, a buffer circuit Bf is connected to one of the input single lines branched into two parts, while the negative logic circuit N is connected to the other. On each of output sides of the buffer circuit Bf and the negative logic circuit N, a resistor R and the coil L are sequentially connected in series. Also, to the two grounding points Pe1 and Pe2 of the microstrip antenna 11, a capacitor C and a forward-direction diode D are sequentially directed in series, respectively, and the base plate 22 is connected. The output sides of the two coils L are connected between the capacitor C and the diode D, respectively. When an electric current flows through the coil L from either one of the buffer circuit Bf and the negative logic circuit N, the diode D is turned on and grounded. In the switching circuit 12 configured as above, too, the connection control similar to the circuit in FIG. 8A is executed.

The switching circuit 12 shown in FIG. 8C is a configuration using an FET. That is, instead of the diode D in the switching circuit 12 in FIG. 8B, FETs 32a and 32b are grounded at terminals of drain and source. An output side of each coil L is connected to a gate terminal of each of the FETs 32a and 32b. Either one of the FETs 32a and 32b is turned on by either one of the buffer circuit Bf and the negative logic circuit N and grounded. In the switching circuit 12 configured as above too, the connection control similar to the circuits in FIGS. 8A and 8B is executed. In the switching circuit 12, the two coils may be omitted.

As the switching circuit 12, various types of switching circuit can be applied as appropriate other than the above three circuits.

Here, the most distinctive characteristic of the reader 1 in this embodiment is that in the microstrip antenna 11 disposed on the reader antenna unit 3, switching is made such that either one of the two grounding points Pe1 and Pe2 is connected to the base plate 22. As a result, while size reduction of the antenna is realized, the direction of the polarization phase in radio communication can be switched. The details will be sequentially described below.

### (A) Principle of Size Reduction

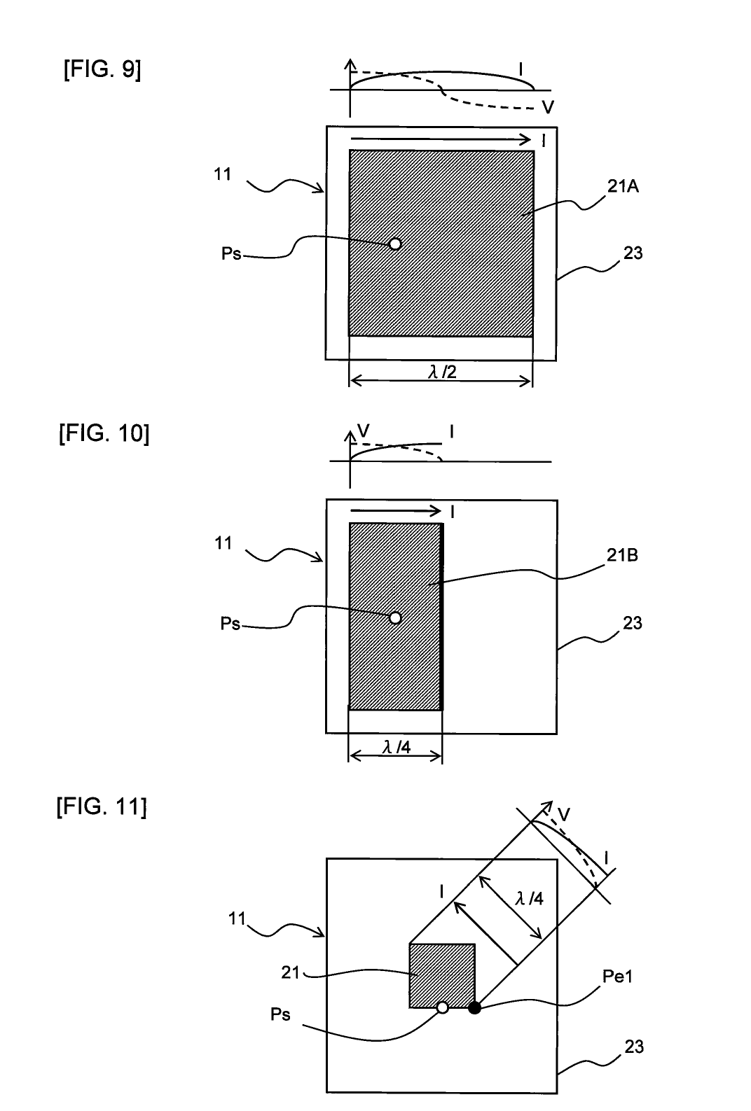

In FIG. 9, a square-shaped microstrip antenna pattern 21A is disposed on a surface of the dielectric substrate 23. A length of one side of the square is substantially a half of a wavelength λ in radio communication, that is, it is approximately a half wavelength or λ/2. The power supply point Ps shown by a framed point (the same applies to the following) is disposed at a position close to a predetermined one side from a center position of the microstrip antenna pattern 21A. In the illustrated example, the power supply point Ps is disposed on one side on the left side from the center position in the microstrip antenna pattern 21A.

As described above, the power supply point Ps is disposed at a position close to one side, and a radio frequency signal is supplied to this power supply point Ps. In this case, an electric current flows in a direction from a side closest to power supply point Ps of the microstrip antenna pattern 21A, that is, from the side on the left side in the figure to the opposite side. As a result, charge distribution becomes the maximum at the center position along the direction, and the charge distribution is substantially 0 at the both end positions along the direction. Also, voltage distribution becomes the maximum in an absolute value with opposite signs to each other, that is, in negative and positive at the both end positions along the direction and the voltage is 0 at the center position along the direction (See a graph in FIG. 9).

Here, at a position where the voltage distribution becomes 0, since a potential is originally 0, an electromagnetic-wave characteristic of the entire microstrip antenna pattern 21A is not affected if grounding is performed at this point. Moreover, when all such points where the voltage distribution becomes 0 gather, it forms substantially a straight line, but if the collected line of the grounding points is grounded, the electromagnetic-wave characteristic is not affected, either. In two areas of the microstrip antenna pattern 21A divided by the collected line of the grounding points as above, the electric current does not flow in an area where the power supply point Ps is not disposed. As a result, as shown in FIG. 10, even if the area is deleted, the microstrip antenna 11 maintains its function (See a graph in FIG. 10). In this state, a length of a short side of a microstrip antenna pattern 21B is approximately one fourth of a wavelength in radio communication, that is, λ/4.

Moreover, the grounding points are disposed so that they gather at one point at either one of the both ends of the collected line, that is, a corner part. In this case, due to the reason similar to the above, an area of the microstrip antenna pattern 21B substantially in a rectangular shape can be reduced to a half along the longitudinal direction of the rectangle. With this configuration, the electric current flows in a direction from the corner part where the grounding point Pe1 is disposed to the opposite corner part on a diagonal line. As a result, the microstrip antenna pattern 21 can be formed so that a length of the diagonal line with which a length of the current-flowing path becomes the longest is approximately one fourth of the wavelength in radio communication, that is, λ/4. FIG. 11 shows the microstrip antenna pattern 21 formed with such dimensional setting (See a graph in FIG. 11). It is known that the size of the microstrip antenna pattern 21 shown in FIG. 11 is considerably reduced as compared with the microstrip antenna pattern 21A having one side with a size of a half wavelength shown in FIG. 9. In this case, the power supply point Ps can be installed on the outer edge portion on one side adjacent to the corner part where the grounding point Pe1 is disposed.

### (B) Configuration in This Embodiment

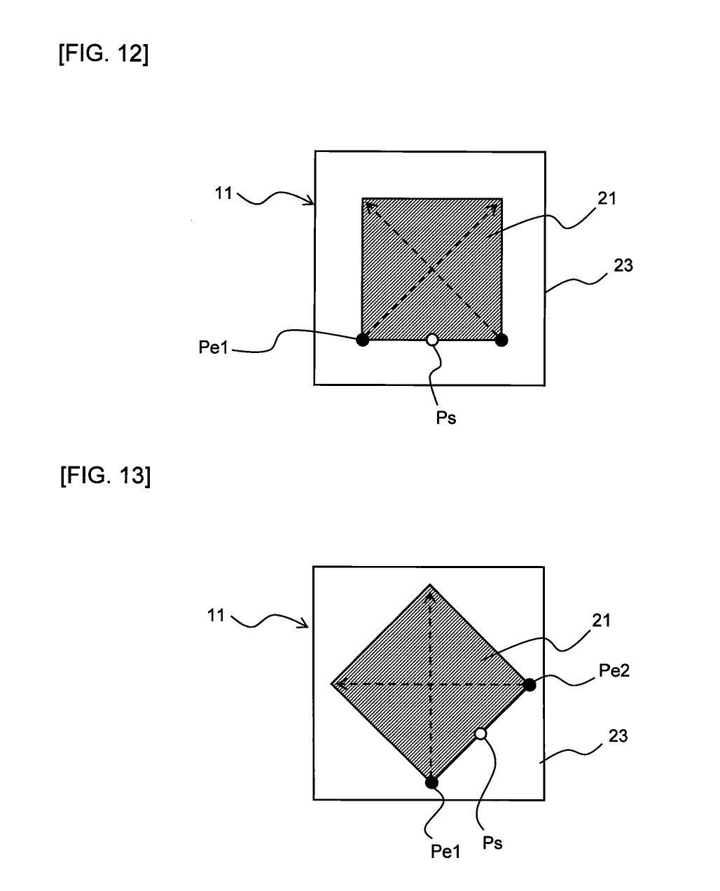

In this embodiment, based on consideration in the above (A), a configuration as shown in FIG. 12 is employed. That is, at both ends of one side of the microstrip antenna pattern 21 formed in a square shape, that is, one side on the lower side in the figure, the grounding points Pe1 and Pe2 are provided, respectively. Also, the power supply point Ps is disposed at an intermediate position on the side on the lower side (See FIG. 6). That is, the distance from the grounding point Pe1 to the power supply point Ps and the distance from the grounding point Pe2 to the power supply point Ps is substantially equal to each other. In the microstrip antenna 11 in this embodiment configured as above, either one of the two grounding points Pe1 and Pe2 is connected to the base plate 22, and a radio frequency radio signal is inputted into the power supply point Ps. In this case, the electric current flows on the diagonal line from the grounding point Pe1 or Pe2 connected to the base plate 22, and a current communication direction of the electric current, that is, a diagonal direction becomes a direction where a potential in the radio wave is changed, that is, a polarization phase direction.

As a result, by switching such that either one of the two grounding points Pe1 and Pe2 is connected to the base plate 22, the polarization phase direction is switched. As a result, in the microstrip antenna pattern 21 in this embodiment particularly formed in the square shape as illustrated, the two polarization phase directions switched to cross each other at a right angle.

As having been described above, in this embodiment, the grounding points Pe1 and Pe2 are arranged at positions on a reference line where the voltage distribution becomes 0 in the microstrip antenna pattern 21. Also, by arranging the grounding points Pe1 and Pe2 at end portions of the antenna pattern 21, a length direction in the current flow direction of the antenna pattern 21 can be reduced to a half while a normal radio communication function is maintained. Also, since the two grounding points Pe1 and Pe2 are provided for the one power supply point Ps, by selectively switching the grounding points Pe1 and Pe2 in use, the direction of the current flowing on the antenna pattern 21 can be switched. As a result, the direction of the polarization phase can be changed without providing two power supply points. As described above, a small-sized microstrip antenna whose direction of the polarization phase in communication is variable can be realized.

Also, particularly in this embodiment, by providing the grounding points Pe1 and Pe2 on the outer edge portion of the microstrip antenna pattern 21, the electric current can be made to flow from the outer edge portion where the grounding points Pe1 and Pe2 are located toward the outer edge portion on the opposite side. At this time, the two grounding points Pe1 and Pe2 are disposed so as to sandwich the single power supply point Ps. As a result, if the electric current flows from the outer edge portion where the grounding points Pe1 and Pe2 are located toward the outer edge portion on the opposite side, the direction can be made considerably different and to cross each other at an angle close to approximately 90°. As a result, the two polarization phase directions substantially crossing each other at a right angle can be switched for use.

Particularly in this embodiment, the microstrip antenna pattern 21 is formed in a quadrangle shape, especially in a square shape in this example. The two grounding points Pe1 and Pe2 are provided at both end portions on one side of the quadrangle, and the single power supply point Ps is disposed at the intermediate part of the side of the quadrangle. As a result, a small-sized square antenna can be realized, and by selectively switching the two grounding points Pe1 and Pe2, two linear polarizations crossing each other at a right angle can be switched for use.

In use by switching the two linear polarization phases crossing each other at a right angle as above, as shown in FIG. 13, the microstrip antenna pattern 21 may be formed so as to have an offset angle with respect to the dielectric substrate 23. In this case, by making each side of the dielectric substrate 23 and the two polarization phase directions parallel, a reference of the polarization phase direction, which is actually invisible, is made clear. As a result, such an effect is exerted that handling of the microstrip antenna 11 is facilitated.

Also, particularly in this embodiment, the power supply point Ps is disposed at a midpoint of the two grounding points Pe1 and Pe2. As a result, whichever of the grounding points is selected, the impedance of the antenna is hardly changed, and the same matching circuit 341 can be used.

Also, particularly in this embodiment, the switching circuit 12 is a switch circuit provided with two 1-input and 1-output switches (See FIG. 8A). As a result, a switching device can be easily realized with a simple structure. Also, by arranging the switching circuit 12 close to the two grounding points Pe1 and Pe2, the potential close to the grounding points Pe1 and Pe2 can be made reliably a ground potential, that is, a 0 potential in view of a radio frequency. Also, if the switching circuit 12 is configured by the switching circuit 12 (See FIGS. 8B and 8C) provided with a plurality of diodes D or FETs 32, a switching device with a smaller size and more inexpensive can be realized.

The present invention is not limited to this embodiment but capable of various variations in a range not departing from its gist and technical idea. Such variations will be sequentially described below.

For example, if a microstrip antenna pattern formed in a circular shape is used, the configuration in which the square shaped microstrip antenna pattern 21 is disposed on the microstrip antenna 11 is described, but the present invention is not limited to that. That is, a microstrip antenna pattern formed in a circular shape, for example, may be used.

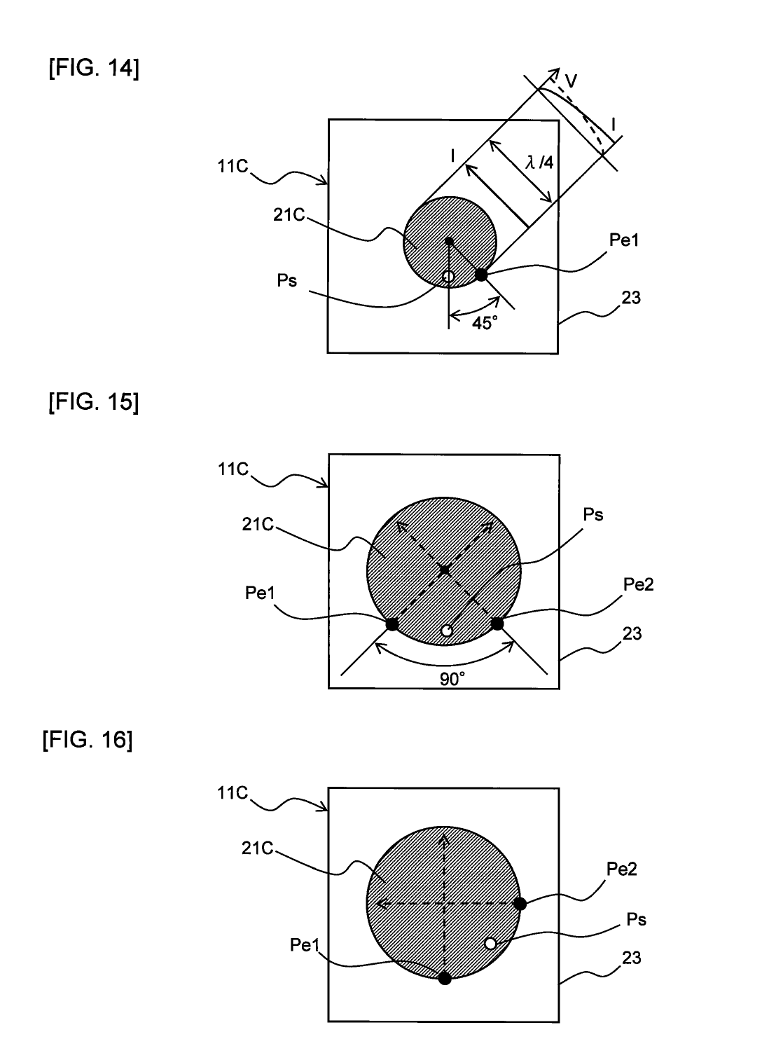

FIG. 14 is a diagram corresponding to FIG. 11 in the embodiment. Also, FIG. 15 is a plan view illustrating a configuration of a microstrip antenna in this variation and a diagram corresponding to FIG. 12 in the embodiment. The same reference numerals are given to portions equivalent to those in the microstrip antenna 21 in the embodiment, and description will be omitted as appropriate. The same applies to each of the drawings shown below.

A microstrip antenna pattern 21C of an example shown in FIG. 14 is formed substantially in a circular shape. A diameter of the microstrip antenna pattern 21C is set at approximately λ/4, which is one fourth of a wavelength in radio communication according to the above-described principle. The power supply point Ps is disposed at a position close to the outer edge portion. One grounding point Pe1 is disposed on an outer periphery edge portion in a direction forming an angle of approximately 45° with the power supply point Ps when seen from the center of the circle. By configuring as above, the electric current flows from the grounding point Pe1 toward a diameter direction through the center point (See a graph in FIG. 14). As a result, the function of the normal microstrip antenna can be ensured despite a small-sized circular shape.

Then, as the microstrip antenna pattern 21C of this variation shown in FIG. 15, the two grounding points Pe1 and Pe2 are provided, and only either one of these two is switched to be connected to the base plate 22 similarly to the embodiment. As a result, the two polarization phase directions can be switching-controlled. In this case, a line connecting the one grounding point Pe1 to the center of the circle and a line connecting the other grounding point Pe2 to the center of the circle cross each other substantially at 90°, and the power supply point Ps is located in the middle of the two grounding points Pe1 and Pe2. As a result, since the two polarization phase directions cross each other at a right angle, the same effect as that in the embodiment can be obtained.

As shown in FIG. 16 corresponding to FIG. 13, the circular strip antenna pattern 21C may be formed with respect to the dielectric substrate 23 formed in a quadrangle shape. As illustrated, an offset angle is provided so that each side of the dielectric substrate 23 and the two polarization phase directions are parallel with each other. In this case, too, similarly to FIG. 13, the reference of the polarization phase direction is made clear, and handling can be facilitated.

Other than those described above, methods of the embodiment and each variation may be combined as appropriate for use. Though not specifically exemplified, the present invention can be put into practice with various changes made in a range not departing from the gist of the invention.

What is claimed is:

1. A microstrip antenna comprising:
a substrate constructed by a dielectric body;
a microstrip antenna pattern configured to be supplied power, formed on one side of said substrate; and
a base plate disposed on the other side of said substrate,
said microstrip antenna pattern having one power supply point to be connected to a power supply line and two grounding points to be connected to said base plate.

2. The microstrip antenna according to claim 1, wherein:
said one power supply point and said two grounding points are disposed on an outer edge portion of said microstrip antenna pattern; and
said two grounding points are arranged on one side from the power supply point and the other side from the power supply point, respectively, so that said one power supply point is sandwiched.

3. The microstrip antenna according to claim 2, wherein:
said two grounding points are arranged so that distances from said one power supply point are substantially equal to each other.

4. The microstrip antenna according to claim 2, further comprising
a switching device configured to selectively connect either one of said two grounding points to said base plate.

5. The microstrip antenna according to claim 4, wherein:
said switching device is a switching circuit having two 1-input and 1-output switches.

6. The microstrip antenna according to claim 4, wherein:
said switching device is a switching circuit having a plurality of diodes or FETs.

7. The microstrip antenna according to claim 1, wherein:
said microstrip antenna pattern has substantially a quadrangle shape;
said two grounding points are disposed at both end portions of one side of said quadrangle; and
said one power supply point is disposed at an intermediate part of the side of said quadrangle.

8. The microstrip antenna according to claim 7, wherein:
said microstrip antenna pattern has substantially a square shape.

9. The microstrip antenna according to claim 1, wherein:
said microstrip antenna pattern has substantially a circular shape; and
said two grounding points are arranged so that an angle formed by a line including the center of said circle and one of the two grounding-point, and a line including the center of said circle and the other of the two grounding-point, is approximately 90°.

10. An apparatus for reading RFID tag information comprising:
an apparatus antenna configured to conduct information transmission and reception with a plurality of a radio frequency identification (RFID) tag circuit elements having an IC circuit part storing information and a tag antenna connected to the IC circuit part; and
a control device configured to control a polarization phase of communication by said apparatus antenna;
said apparatus antenna being a microstrip antenna having:
a substrate constructed by a dielectric body;
a microstrip antenna pattern formed on one side of said substrate and having one power supply point for connection to a power supply line and two grounding points for connection to a base plate; and
said base plate disposed on the other side of said substrate.
